(19) United States
(12) Patent Application Publication
(10) Pub. No.: US 2010/0108486 A1
(43) Pub. Date: May 6, 2010

(54) METAL DOME SHEET HAVING PRESSING PROJECTION, PUSH BUTTON SWITCH, AND METHOD OF PRODUCING THE PUSH BUTTON SWITCH

(76) Inventor: Minoru Yoshida, Niigata (JP)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/532,508

(22) PCT Filed: Apr. 17, 2008
(86) PCT No.: PCT/JP2008/057468

§ 371 Date: Sep. 22, 2009

(30) Foreign Application Priority Data
Apr. 18, 2007 (JP) 2007-108939

(51) Int. Cl. H01H 13/02; H01H 11/00

(52) U.S. Cl. 200/520; 29/622; 200/310

(57) ABSTRACT

To provide a metal dome sheet 10 to which a metal dome 8 is attached. The metal dome 8 elastically deforms with a pressing operation of a key top 16, thereby to have electrical conduction with a contact 6 provided on a substrate 2, and restores from a deformed state when the pressing operation is released, thereby to release the conduction with the contact. The metal dome sheet 10 has an elastic pressing projection 12 which transmits pressing force applied from the key top 16 side to a top 8a of the metal dome 8.

### INDUSTRIAL FIELD OF APPLICATION

The present invention relates to a member to be used for push button switches of portable electronic devices including a cellular phone and a personal digital assistance (PDA), and, particularly, to a metal dome sheet to which metal dome(s) are attached, and a push button switch using the metal dome sheet.

### RELATED ART

Portable electronic devices including a cellular phone and a personal digital assistance (PDA) become popular, and push button switches which are used in those portable electronic devices are widely used. Such a push button switch often has a fixed contact provided on a substrate, an elastic metal dome (which functions as a movable contact) arranged to cover the contact, and a key top member arranged above the metal dome. (Hereinafter, the substrate side and operational surface side of the push button switch will be described as bottom side and top side, respectively.)

According to the push button switch having such a structure, when an operator presses the top surface of the key top, the pressing force is transmitted to the metal dome which elastically deforms to have conduction with the contact provided on the substrate. When the operator stops the pressing operation, the pressing force applied to the metal dome is released, so that the metal dome is restored from the deformed state to release the conduction with the contact. Such a pressing operation and release of the operation allow the push button switch to function as an ON/OFF switch.

In order to obtain good clicking feeling at the operation time when the pressing force generated by the pressing operation is transmitted to the metal dome from the key top side, the bottom side of each key top is often provided with a pressing projection formed of an elastic material, particularly, an elastic material called a plunger.

Since each push button switch needs to have a metal dome, individual metal domes should be arranged at locations where the respective push button switches are set in the case where a plurality of push button switches are provided on a single substrate. In order to cope with it, a plurality of metal domes are often attached to a metal dome sheet which is molded integrally, and then mounted on a substrate so that the individual metal domes can be arranged on the substrate at predetermined positions.

Among such push button switches, there are widely used push button switches which use a back light to permit illuminated light to be transmitted from the bottom side of the key top to display a character, numeral or the like provided on the push button in order to improve the operability and decoration of the push button switch. In such push button switches using a back light, there is proposed a push button switch which has a light guide plate to guide illuminated light supplied from one light source to a plurality of key tops in order to reduce the number of light sources for supplying the back light (see, for example, Patent Document 1)

### [Patent Document 1] Japanese Patent Application Laid-Open No. 2006-324253

In the process for assembling the foregoing push button switch having a pressing projection under a key top, a metal dome sheet to which metal domes are previously attached is mounted on a substrate, and a key top member having a pressing projection is mounted on the substrate at a position corresponding to each metal dome in the last step for assembly. In this case, it is important to accurately locate the pressing projection at the top of each metal dome to obtain good clicking feeling. However, it is very difficult to mount the key top member in such a way that the position of each pressing projection matches with the position of the top of the respective metal dome in the last step for assembly when a lot of members have already been mounted. It is therefore difficult to stably manufacture a push button switch having good clicking feeling.

In the push button switch described in Patent Document 1, the elastic portion which has the pressing projection provided under the key top also serves as a light guide plate to guide illuminated light. Therefore, any additional light guide plate is not required.

In this push button switch, however, as mentioned above, it is necessary to mount a key top member having a pressing projection at a position corresponding to each metal dome previously mounted on the substrate in the last step for assembly.

Therefore, as mentioned above, it is very difficult to mount the key top member in such a way that the position of each pressing projection matches with the position of the top of the respective metal dome, so that it is difficult to stably manufacture a push button switch having good clicking feeling even though the cost for an additional light guide plate can be saved.

### DISCLOSURE OF THE INVENTION

Accordingly, it is an object of the present invention to solve the foregoing problems and provide a member for a push button switch which can allow a pressing projection to be accurately positioned with the top of a metal dome, and provide a member for a push button switch which further has a function of a light guide plate to guide illuminated light for a back light.

It is another object of the present invention to provide a push button switch using the member, and a method of manufacturing the push button switch.

To solve the above mentioned problems, as one aspect of a member for a push button switch according to the present invention, there may be provided a metal dome sheet to which metal dome(s) are attached, said metal dome elastically deforms with a pressing operation of a key top, thereby to have electrical conduction with a contact provided on a substrate, and restores from a deformed state when the pressing operation is released, thereby to release the conduction with said contact, said metal dome sheet having an elastic pressing projection which transmits pressing force applied from the key top side to a top of said metal dome.

As one aspect of a push button switch according to the present invention, there may be provided a push button switch comprising: a key top; a metal dome which elastically deforms with a pressing operation of the key top, thereby to have electrical conduction with a contact provided on a substrate, and restores from a deformed state when the pressing operation is released, thereby to release the conduction with said contact; a metal base sheet to which said metal dome(s) are attached and functioning as a light guide plate, said metal base sheet having an elastic pressing projection which transmits pressing force applied from the key top side to a top of said metal dome, and further having at least one light source mounted to supply illuminated light, and a reflection means which reflects at least a part of the illuminated light toward said key top, said reflection means being provided at an area where said key top is located.

As one aspect of a method of manufacturing a push button switch according to the present invention, there may be provided a method of manufacturing a push button switch using a metal dome sheet having a pressing projection, comprising: a first step of attaching metal dome(s) to the metal dome sheet in such a way that a position of a top of said metal dome matches with a position of said pressing projection; a second step of mounting said metal dome sheet to which said metal dome(s) are attached on a substrate; and a third step of mounting a key top member on said substrate with said metal dome sheet at a position where said metal dome is located.

### BRIEF DESCRIPTION OF THE DIAGRAMS

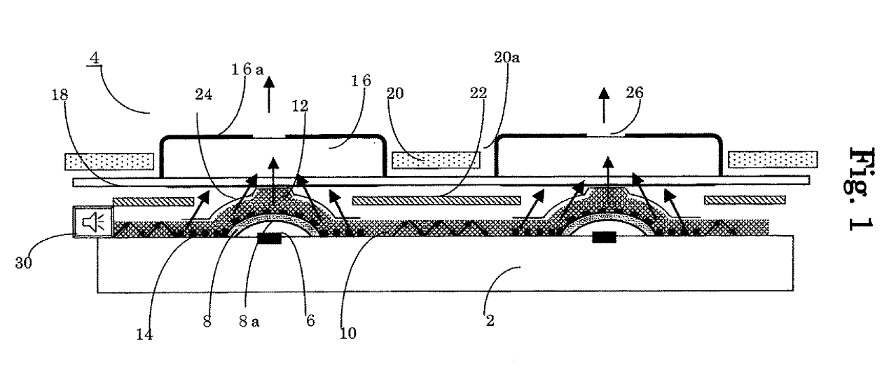

FIG. 1 is a side cross-sectional view showing a structure of a push button switch using a metal dome sheet according to the present invention.

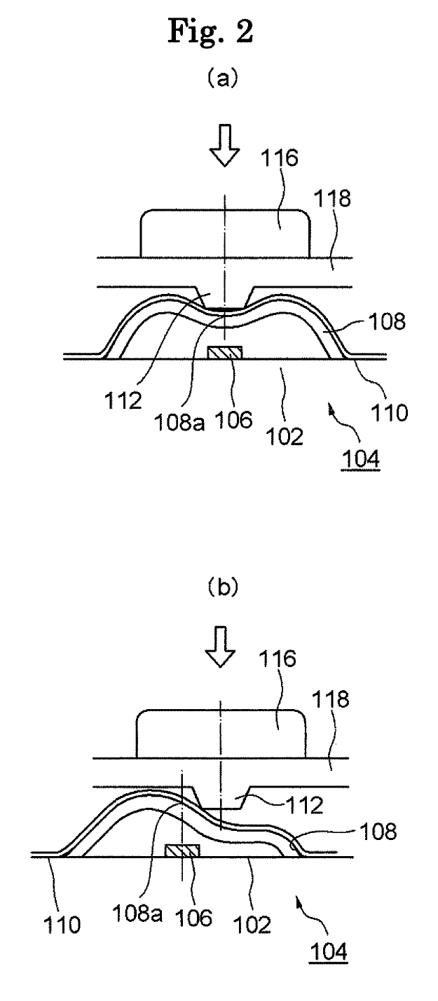

FIG. 2 is a diagram exemplarily illustrating the top of a metal dome being pressed with a pressing projection in a conventional push button switch.

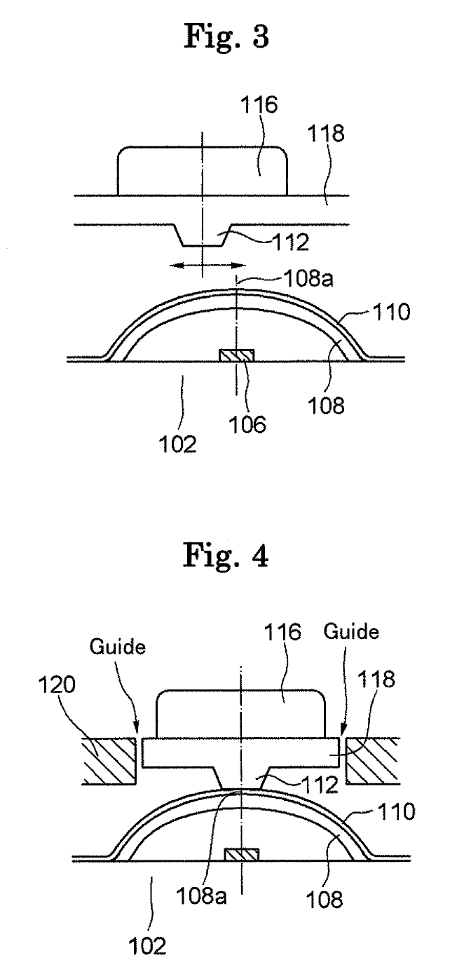

FIG. 3 is a diagram exemplarily illustrating attachment of a key top member having a pressing projection onto the metal dome in assembling the conventional push button switch.

FIG. 4 is a diagram showing another structure of the conventional push button switch.

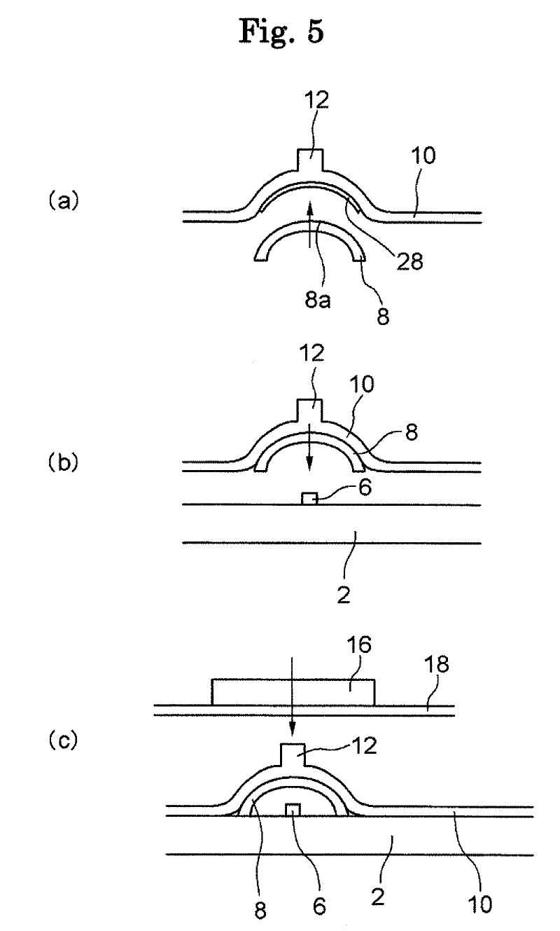

FIG. 5 is a diagram showing essential steps of assembling a push button switch using a metal dome sheet according to the present invention.

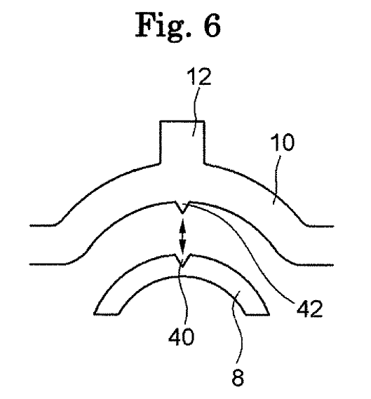

FIG. 6 is a diagram showing one embodiment when a metal dome is attached to the metal dome sheet in assembling the metal dome sheet according to the present invention.

### DETAILED DESCRIPTION OF THE INVENTION

### General Description

As one embodiment of a member for a push button switch according to the present invention, there may be provided a metal dome sheet to which metal dome(s) are attached, said metal dome elastically deforms with a pressing operation of a key top, thereby to have electrical conduction with a contact provided on a substrate, and restores from a deformed state when the pressing operation is released, thereby to release the conduction with said contact, said metal dome sheet having an elastic pressing projection which transmits pressing force applied from the key top side to a top of said metal dome.

One example of push button switches using the metal dome sheet according to the embodiment is configured in such a way that (Note: the substrate side being a bottom side and the operational surface side being a top side) contacts are provided on a substrate, a metal dome sheet having pressing projections to which metal domes are attached is mounted over the contacts, and key top members are mounted at positions above the metal dome sheet which correspond to the respective metal domes. The “key top member” means a member constructed by a key top and a key base attached to the bottom side of the key top.

The metal domes are attached to the metal dome sheet in such a way that the position of the top of each metal dome matches with the position of the pressing projection. The pressing projection is configured to transmit pressing force from the key top side to the top of the metal dome. The vertical arrangement relating to one push button switch is such that the contact on the substrate, the metal dome, the metal dome sheet, the pressing projection which is a part of the metal dome sheet, the key base and the key top are arranged in order from bottom to top.

In the push button switch with such a structure, when an operator presses the top surface (operational surface) of the key top, the pressing force is transmitted to the pressing projection located under the key top via the key base, and further the pressing projection presses the top of the metal dome. The pressing force elastically deforms the metal dome to establish electric conduction with the contact provided on the substrate, establishing a switch ON state. When the operator stops pressing the key top, the pressing force is released, so that the metal dome is restored from the deformed state to release the conduction with the contact. This provides a switch OFF state. In order to obtain good clicking feeling when pressing the key top, the pressing projection needs to have certain elasticity.

The “key top” is a member corresponding to a push button of a push button switch, and a character, numeral, symbol, figure or the like is normally displayed on the key top for the key top to function as the push button of a switch. As will be described later, those characters, numerals or the like are represented by so-called outlined characters, and illuminated light (back light) from the bottom surface side of the key top is transmitted trough the outlined characters, so that the characters, numerals or the like can be displayed. For example, a metal as well as a resin can be used as the material for the key top.

The “metal dome” is a domed metal member which serves as a contact elastically deformable with pressing force applied by the pressing operation of the key top. Any metal having a predetermined strength, elasticity, electric conductivity and workability can be used as the material for the metal dome. If a layer with a high electric conductivity can be provided at the contact portion by plating, coating or the like, a wider range of materials can be used for the metal dome.

Since the metal dome needs to be provided for each push button switch, individual metal domes can be arranged at positions corresponding to the respective key tops by attaching a plurality of metal domes to a single “metal dome sheet”. One example of an available method of attaching the metal domes to the metal dome sheet is using an adhesive, however, various other fixing methods such as welding and the use of a coupling member, can be used as well.

The “pressing projection” that has elasticity to transmit the pressing force applied from the key top side to the top of the metal dome is also called plunger. The pressing projection is provided between the key top and the metal dome, and has a function of providing adequate clicking feeling when the key top is pressed. Therefore, the pressing projection needs to have a certain thickness (size in the pressing direction) in order to have elasticity large enough to provide clicking feeling.

While the metal dome sheet is provided with the pressing projections in the embodiment, the provision of the pressing projections at the metal dome sheet can be achieved by integrally forming the pressing projections with the metal dome sheet, or forming the pressing projections and the metal dome sheet separately and then connecting the pressing projections and the metal dome sheet using an adhesive, welding or the like.

As the material for the metal dome sheet, an elastic material is desirable in the case of integrally forming the pressing projections and the metal dome sheet; for example, an ultraviolet curing resin, silicone rubber, thermoplastic elastomer or the like can be used. In the case of forming the pressing projections and the metal dome sheet separately and then connecting them together, the pressing projection portion may be formed of the aforementioned elastic material and the metal dome sheet portion may be formed of a resin material similar to that of the key top.

In the case of assembling a metal dome sheet having the conventional pressing projection attached under the key top, it is necessary to mount key top members having the pressing projections on the substrate at positions corresponding to the respective metal domes in the last step for assembly. In this case, it is very difficult to mount the key top members in such a way that the position of each pressing projection matches with the position of the top of the respective metal dome on the condition where a lot of members have already been mounted.

According to the embodiment, each metal dome can be attached to the metal dome sheet before mounted on the substrate, so that it is relatively easy to attach the metal domes to the metal dome sheet in such a way that the position of the top of each metal dome matches with the position of the pressing projection provided at the metal dome sheet. In this case, positioning can be carried out using a jig. Alternatively, accurate positioning can be achieved by previously providing a concavo-convex pattern at the metal domes by emboss processing or the like, also previously providing a concavo-convex pattern at the metal dome sheet, and fitting the concaves and convexes of both patterns.

While it is also necessary to mount each key top above the respective key dome in the last step of the push button switch assembly, the positioning of the top of the metal dome with the pressing projection has already completed and the key top having a larger bottom area than the pressing projection has only to be arranged at an area corresponding to the metal dome, so that the conventional severe positioning precision is not needed.

According to the embodiment, therefore, the push button switch can be assembled with the position of the pressing projection being accurately positioned with the top of the respective metal dome. This makes it possible to stably manufacture the push button switch having good clicking feeling.

As another embodiment of the member for the push button switch according to the present invention, there may be provided a metal dome sheet, comprising: at least one light source mounted to supply illuminated light; and a reflection means which reflects at least a part of the illuminated light toward said key top, said reflection means being provided at an area where said key top is located, whereby said metal dome sheet functions as a light guide plate.

The “light guide plate” so-called light guide is a member to supply light generated from one light source to a plurality of key tops while reducing attenuation. Various materials including a resin and glass can be used as the material for the light guide plate as long as the material has transparency or translucency.

For example, a light emitting diode (LED) can be used as the “light source” to supply illuminated light. Any other light source such as a cold-cathode tube can be used as well.

The “reflection means” which reflects at least a part of illuminated light toward the key top is a means which diffuses at least a part of illuminated light traveling in the light guide plate to change its traveling direction to enter the key top. As a specific embodiment of the reflection means, for example, the reflection means can be formed by printing reflection dots by white ink on the bottom surface of the metal dome sheet serving as a light guide plate, or providing undulations on the bottom surface of the metal dome sheet with a stamper or injection, or adhering a reflector to the bottom surface of the metal dome sheet with a dots-patterned adhesive. Any other reflection means which reflects light can be used.

According to the embodiment, since the metal dome sheet serves as a light guide plate, it is possible to reduce the number of light sources for push button switches using back light without requiring an additional dedicate light guide plate. As compared with the case where the key base portion connected to the bottom side of the key top is used as a light guide plate, this embodiment can have a light source on the substrate, thus ensuring space-efficient layout of light sources, and ensuring efficient wiring. Further, the light source can be provided with a function other than the function of supplying back light by using this arrangement of the light source.

As another embodiment of the member for the push button switch according to the present invention, there may be provided a metal dome sheet, wherein a colored layer is provided at the area where said reflection means is provided.

A colored layer can be provided at any area where the reflection means of the metal dome sheet is provided. When the reflection means is provided at the bottom side of the metal dome sheet, for example, the colored layer can be provided at the top side of the metal dome sheet, or the colored layer can be provided at the bottom side of the metal dome sheet, or the colored layer can be provided inside the metal dome sheet. That is, the colored layer can be provided at any position where illuminated light can pass through to enter the key top by the reflection means. As a method of providing the colored layer, any coloring means, such as printing, can be used.

According to the embodiment, even when white light is generated from a light source, it is possible to supply illuminated light having desired color to the key top as back light by making the light pass through the colored layer. This makes it possible to provide a highly decorative push button switch whose key top is illuminated with light of various colors. The provision of the colored layer at the key top portion can allow the key top to be illuminated with light of various colors. When the colored layer is provided on the key top, the key top is displayed by the color of the colored layer even when illuminated light is off.

When the colored layer is provided at the metal dome sheet, on the other hand, the key top is displayed by the color of the colored layer only when illuminated light is on, which can provide an operator with unexpected or strong impression and can provide a push button switch attractive to the operator.

As one embodiment of the push button switch according to the present invention, there may be provided a push button switch comprising: a key top; a metal dome which elastically deforms with a pressing operation of the key top, thereby to have electrical conduction with a contact provided on a substrate, and restores from a deformed state when the pressing operation is released, thereby to release the conduction with said contact; a metal base sheet to which said metal dome(s) are attached and functioning as a light guide plate, said metal base sheet having an elastic pressing projection which transmits pressing force applied from the key top side to a top of said metal dome, and further having at least one light source mounted to supply illuminated light, and a reflection means which reflects at least a part of the illuminated light toward said key top, said reflection means being provided at an area where said key top is located.

According to the embodiment, as mentioned above, the push button switch can be assembled in such a way that each pressing projection is accurately positioned with the top of the respective metal dome, so that the push button switch having good clicking feeling can be stably manufactured. Further, as the metal dome sheet serves as a light guide plate, it is possible to provide a push button switch which can reduce the number of light sources without adding a new item such as a dedicate light guide plate.

As one embodiment of a method of manufacturing a push button switch according to the present invention, there may be provided a method of manufacturing a push button switch using a metal dome sheet having a pressing projection, comprising: a first step of attaching metal dome(s) to the metal dome sheet in such a way that a position of a top of said metal dome matches with a position of said pressing projection; a second step of mounting said metal dome sheet to which said metal dome(s) are attached on a substrate; and a third step of mounting a key top member on said substrate with said metal dome sheet at a position where said metal dome is located.

According to the embodiment, as mentioned above, the push button switch can be assembled in such a way that each pressing projection is accurately positioned with the top of the respective metal dome, so that the push button switch having good clicking feeling can be stably manufactured.

### EFFECT OF THE INVENTION

According to the metal dome sheet according to the present invention, the push button switch using this metal dome sheet, and a method of manufacturing the push button switch, as described above, the push button switch can be assembled in such a way that each pressing projection is accurately positioned with the top of the respective metal dome, so that the push button switch having good clicking feeling can be stably manufactured.

In addition, when the metal dome sheet serves as a light guide plate, it is possible to provide a push button switch which can reduce the number of light sources without adding a new item such as a dedicate light guide plate. Since it is also possible to provide a light source at the substrate, there are various advantages on the layout, wiring and functions.

Further, when a colored layer is provided at the area of the reflection means, illuminated light of desired color can be supplied to the key top member as back light, thus making it possible to provide a highly decorative push button switch whose key top is illuminated with light of various colors.

### DESCRIPTION OF ILLUSTRATED EMBODIMENTS

Embodiments of a metal dome sheet according to the present invention, and a push button switch using this metal dome sheet will be explained in detail below referring to the accompanying drawings.

### (Description of Embodiments of Metal Dome Sheet and Push Button Switch According to the Invention)

### <Description of General Structure of Push Button Switch According to the Invention>

At first, using FIG. 1, the general structure of one embodiment of a push button switch using a metal dome sheet according to the invention will be described. FIG. 1 is a side cross-sectional view showing the structure of a push button switch 4 using a metal dome sheet according to the present invention. Hereinafter, the operational surface side (top side of the key top) and substrate side of the push button switch 4 will be described as top side and bottom side, respectively.

While two push button switches 4 are provided on a substrate 2 in the embodiment shown in FIG. 1, an arbitrary number of push button switches 4 can actually be provided on the substrate 2. In each push button switch 4 shown in FIG. 1, a fixed contact 6 is provided on the substrate 2 and a metal dome 8 which is a domed metal part is arranged at an upper position to cover the contact 6. In the embodiment, each metal dome 8 is attached to one metal dome sheet 10 arranged over the metal dome by an adhesive. Pressing projections (plungers) 12 having an elasticity which are integrally molded with a sheet portion are provided on the top side of the metal dome sheet 10. A key top member 16, 18 having each key top 16 attached to a single sheet-like key base 18 is arranged over the pressing projection 12.

As apparent from FIG. 1, there are the metal dome 8 and the key top 16 for one push button switch 4, and when a plurality of push button switches 4 are provided, a plurality of metal domes 8 and a plurality of key tops 16 need to be mounted at positions where the push button switches 4 are to be arranged. In the embodiment, therefore, before mounting on the substrate 2, a plurality of metal domes 8 are previously attached to the metal dome sheet 10 or a common sheet by an adhesive, and a plurality of key tops 16 are attached to the key base 18 or a common sheet by an adhesive. Accordingly, the layout of the metal domes 8 and key tops 16 is determined previously, and can easily be mounted on the substrate 2 at predetermined positions. However, this is not restrictive, and the metal domes 8 and key tops 16 may be mounted on the substrate 2 respectively.

In the push button switch 4 with the above mentioned structure, when an operator presses the top surface (operational surface) 16a of the key top 16, the pressing force is transmitted to the pressing projection 12 located under the key top via the key base 18. The pressing projection 12 further transmits the pressing force downward to press the top 8a of the metal dome 8. The pressing force elastically deforms the metal dome 8 downward to establish electric conduction with the contact 6 provided on the substrate 2, so that the push button switch 4 is set to an ON state. When the operator stops pressing the key top 16, the pressing force is released, so that the metal dome 8 returns to the initial position from the deformation position to stop the conduction with the contact 6. This sets the push button switch 4 to an OFF state.

The metal dome sheet of the embodiment also serves as a light guide plate to transmit illuminated light from a light source in order to supply illuminated light to the key top as back light. As shown in FIG. 1, a light source 30 is attached to the left side of the metal dome sheet 10 in the sheet of the diagram, and illuminated light from the light source 30 travels in the metal dome sheet 10 from the left side to the right side in the sheet of the diagram as indicated by arrows in FIG. 1. When the illuminated light reaches the position on the left side in the sheet of the diagram where the push button switch 4 is located, a part of the illuminated light is diffused by reflection means 14 provided at the bottom side of the metal dome sheet 10. Then, a part of the diffused illuminated light travels toward the upper key top 12, and passes through the key base 18 to enter the key top 16. The input illuminated light travels upward inside the key top 16, passes through an a numeral, character, symbol, figure or the like 26 represented by an outlined character, and reaches the top surface of the key top 16. This allows the illuminated light to make the character, numeral or the like 26 clearly displayed, so that the push button switch 4 serves as an illuminated light key.

Meanwhile, illuminated light which has not been diffused by the reflection means 14 further travels inside the metal dome sheet 10 approximately horizontally from the left side to the right side in the sheet of the diagram, and reaches the position on the right side in the sheet of the diagram where the push button switch 4 is located. As mentioned above, a part of the illuminated light is diffused by the reflection means 14 provided on the bottom side of the metal dome sheet 10, and a part of the diffused illuminated light enters the key top 16 as indicated by the arrows in FIG. 1, making the character, numeral or the like 26 clearly displayed. Accordingly, the push button switch 4 on the right side in the sheet of the diagram serves as an illuminated light key.

While only two push button switches 4 are illustrated in FIG. 1, when other push button switches 4 are arranged, uniform illuminated light can be supplied to all the key tops 16. Means for supplying uniform illuminated light to all the key tops 16 will be described below.

While the reflection means is provided on the bottom side of the metal dome sheet, as described above, a colored layer 24 is further provided above the area of the metal dome sheet 10 where the reflection means 14 is provided. Even if white light is supplied from the light source 30, the key top 16 can be illuminated with light having a desired color according to the colored layer 24 by making illuminated light which will enter the key base 16 pass through the colored layer 24.

Further, in order to prevent illuminated light from leaking from a clearance 20a between the key top 12 and a casing 20 of an electronic device, a mask sheet 22 is located between the adjacent key tops 16 in the embodiment. As a material for the mask sheet, a resin material, for example, can be used. Alternatively, a light shielding layer may be directly formed on the top surface or bottom surface of the key base 16 at an area where light is to be shielded, using a light shielding coating, instead of using the mask sheet.

As a material for the key top 16, a metal as well as a resin can be used, and any other various materials can also be used. If a resin is used as a material for the key top 16, various resins, such as a polycarbonate (PC) resin, polyethylene terephthalate (PET) resin, can be used, and a mixture of those resins can be used as well. As a material for the key base 18, a material similar to that for the key top 16 can be used, and an elastic material can be used to assist obtaining clicking feeling. In this case, silicone rubber, thermoplastic elastomer, ultraviolet curing resin or the like can be used.

An example of the thickness of the key top 16 is 0.2 mm to 5 mm, and an example of the thickness of the key base 18 is 0.1 mm to 0.2 mm, however it is not restrictive.

### <Description of Metal Dome Sheet According to the Invention>

In the next place, one embodiment of the metal dome sheet according to the invention will be described in detail referring to FIGS. 1 to 6.

### <<Description of Assembling Method>>

At first, the description of assembling the push button switch using the metal dome sheet according to the invention will be given in comparison with the method of assembling the convention push button switch.

To begin with, the structure of a conventional push button switch 102 will be described referring to FIG. 2. In the push button switch 102 shown in FIG. 2, a pressing projection 112 is formed integrally with a key base 118 attached to the bottom surface of the key top 116. A contact 106 is provided on the substrate 102, and a metal dome 108 attached to the metal dome sheet 110 is arranged above the contact. However, the metal dome sheet 110 is not provided with a pressing projection.

In the case where an operator presses the push button switch 102 with such a structure, if the push button switch 104 is assembled in such a way that the position of the push button switch 112 matches with the position of a top 108a of the metal dome 108 as shown in FIG. 2(a), the metal dome 108 is uniformly deformed by the pressing force, thus providing the operator good clicking feeling.

If the push button switch 104 is assembled in such a way that the position of the push button switch 112 does not match with the position of the top 108a of the metal dome 108 as shown in FIG. 2(b), the metal dome 108 is deformed in a strained shape by pressing force, thus failing to provide the operator with good clicking feeling.

In the case of assembling the conventional push button switch 102, it is necessary to mount the metal dome sheet 110 to which the metal dome 108 is attached on the substrate 102 beforehand, and mount a key top member 116, 118 having the pressing projection 112 on the substrate 102 at a position corresponding to each metal dome 108 in the last step for assembly.

When a work of assembling a member on the substrate 102 is called online work and a previous work before the online work is called offline work, it is necessary to mount the key top member 116, 118 having the pressing projection 112 on the substrate 102 in the online work for the conventional push button switch 102.

In this case, it is also necessary to mount the key top member 116, 118 in such a way that the position of each pressing projection 112 matches with the position of the top 108a of the respective metal dome 108, in a condition where a lot of members have already been mounted on the substrate 102. The bottom area of the pressing projection 112 is small and each metal dome basically has one top 108a, so that the work of mounting the key top member while positioning both is very difficult. Therefore, the actual assemble state tends to become the one shown in FIG. 2(b), not one shown in FIG. 2(a).

In order to avoid positional deviation between the pressing projection 112 and the top 108a of the metal dome 108, it is possible to provide a guide mechanism to set the position of the key top member 116, 118 within a certain range as shown in FIG. 4. However, this requires working on the key top member 116, 118 and the casing 120 with severe dimensional precision and requires a high manufacturing cost. In addition, there is a restriction on the freedom of design, which is not desirable from the viewpoint of design.

FIG. 5 shows steps for assembling the push button switch 4 according to the present invention.

At first, as shown in FIG. 5(a), the metal dome 8 is attached to the metal dome sheet 10 using an adhesive 28 in the offline work before mounting on the substrate 2. In this case, this work is attaching a single metal dome 8 to the metal dome sheet 10 offline, so that it is relatively easy to attach both members with matching the position of the top 8a of the metal dome 8 with the position of the pressing projection 12 provided at the metal dome sheet 8. In this work, positioning can carried out more reliably by using a jig for positioning.

Further, as shown in FIG. 6, it is possible to provide a concave pattern 40 at the metal dome 8 beforehand by emboss working or the like and form a convex pattern 42 corresponding to the concave pattern 40 on the metal dome sheet 10 beforehand. At the time of attaching the metal dome 8 to the metal dome sheet 10, accurate positioning can be achieved by fitting the convex pattern 42 provided at the metal dome sheet 10 into the concave pattern 40 provided at the metal dome 8.

For the key top member, a work of attaching the key top 16 to the key base 18 using an adhesive is performed before mounting on the substrate 2.

After the metal dome 8 is attached to the metal dome sheet 10 as shown in FIG. 5(a), the metal dome sheet to which the metal domes 8 are attached is mounted on the substrate 2 at a predetermined position where the contact 6 is provided as shown in FIG. 5(b). Then, as shown in FIG. 5(c), in the condition where the metal domes 10 are mounted on the substrate 2, the key top member 16, 18 (i.e., key base 18 to which the key top 16 is attached) is mounted from above.

In this case, with regard to the misalignment of the metal dome 8 with the key top 16, they have already been arranged in such a way that the position of the pressing projection 12 matches with the position of the top 8a of the metal dome 8, and the bottom area of the key top 16 which is normally operated with a finger of a person is considerably larger than the bottom area of the pressing projection 12, so that severe precision as needed in positioning the conventional pressing projection is not required.

According to the method for assembling the pressing projection 4 according to the invention as shown in FIG. 5, therefore, the push button switch 4 can be assembled with the position of the pressing projection 12 being accurately aligned with the position of the top 8a of the metal dome 8, so that the push button switch 4 which provides good clicking feeling can be manufactured.

### <<Description of Detailed Structure of Metal Dome Sheet>>

In the next place, the structure of the metal dome sheet 10 according to the embodiment shown in FIG. 1 will be described in more detail.

As shown in FIG. 1, the metal dome 8 is a metal member having a dome shape. Any metal which has a predetermined strength, elasticity, electric conductivity and workability can be used as the material for the metal dome 8. If a layer with a high electric conductivity can be provided at the contact portion by plating, coating or the like, a wider range of materials can be used for the metal dome 8.

In the description referring to FIG. 5, the metal dome 8 is attached to the metal dome sheet 10 using the adhesive 28. As the adhesive to be used in the attachment, any kind of adhesive which is suitably attached to a resin or rubber material can be used.

The method of attaching the metal dome 8 to the metal dome sheet 10 is not limited thereto, and welding can be used as well.

Since the material for the pressing projection 12 needs to have a certain elasticity to obtain good clicking feeling, it is desirable to use an elastic material. Therefore, an ultraviolet curing resin, silicone rubber, thermoplastic elastomer or the like, for example, are available. In order that the pressing projection 12 can have elasticity enough to provide good clicking feeling at the time of transmitting pressing applied from the key top 16 side to the top 8a of the metal dome 8, it needs to have a certain thickness (size in the pressing direction). The specific example of the thickness may be 0.1 mm to 0.2 mm, however it is not restrictive.

One embodiment where the pressing projection 12 is provided at the metal dome sheet 10 is to mold the pressing projection 12 and the metal dome sheet 10 integrally as shown in FIG. 1. However, this embodiment is not restrictive, and the pressing projection 12 and the metal dome sheet 10 can be formed separately, and then connected together using an adhesive, welding or the like.

As the material for the metal dome sheet 10, an elastic material is desirable in the case of integrally forming the pressing projection 12 and the metal dome sheet 10; for example, an ultraviolet curing resin, silicone rubber, thermoplastic elastomer or the like can be used. In the case where the pressing projection 12 and the metal dome sheet 10 are formed separately and then connected together, the pressing projection portion may be formed of the aforementioned elastic material and the metal dome sheet portion may be formed of a resin material similar to that of the key top.

### <<Description of Case of Functioning as Light Guide Plate>>

In the next place, a detailed description will be given regarding the case where the metal dome sheet 10 according to the embodiment shown in FIG. 1 serves as a light guide plate to transmit illuminated light in order to provide the key top with back light.

The metal dome sheet 10 of the embodiment is made of a material having transparency or translucency to permit transmission of illuminated light while minimizing the attenuation thereof, and available materials can be a resin, glass or the like, for example. The light source 30 which supplies illuminated light can be a light emitting diode (LED), for example, and any other light source such as a cold-cathode tube can be used as well.

A specific structure of the reflection means 14 which reflects at least a part of illuminated light toward the key top 16 can be formed by printing reflection dots on the bottom surface of the metal dome sheet 10 serving as a light guide plate with white ink as shown in FIG. 1.

The more detailed movement of illuminated light traveling inside the metal dome sheet 10 will be described. As indicated by the arrows in FIG. 1, illuminated light from the light source 30 travels approximately in the horizontal direction as the general traveling direction while reflecting between the top surface (inner surface) and the bottom surface (inner surface) of the metal dome sheet 10. When a part of the illuminated light traveling this way reaches the reflection dots at the bottom surface of the metal dome sheet 10, it is reflected by the reflection dots and travels upward toward the key top 16.

The specific embodiment of the reflection means 14 is not limited to reflection dots, and the reflection means can be formed by, for example, providing undulations at the bottom surface of the metal dome sheet by injection, or adhering a reflector to the bottom surface of the metal dome sheet by a dots-patterned adhesive.

The metal dome sheet 10 of the embodiment is provided with means for uniformly supplying illuminated light from a single light source 30 to multiple key tops 16. Specifically, the strength of the reflection means 14 to reflect illuminated light is changed according to the distance from the light source 30. That is, the reflection strength of the reflection means 14 provided near the light source 30 is made weaker, while the reflection strength of the reflection means 14 provided far from the light source 30 is made stronger. A specific method of changing the reflection strength may be achieved by changing the number of reflection dots or the density thereof in case of using the reflection dots, or changing the number of undulations, the size thereof, the depth thereof or the like in case of using the undulations.

In the metal dome sheet 10 of the embodiment, as described above, as the metal dome sheet 10 serves as a light guide plate, it is possible to reduce the number of light sources for supplying back light without requiring an additional dedicated light guide plate. As compared with the case where the key base portion connected to the bottom side of the conventional key top is used as a light guide plate, the metal dome sheet 10 of the embodiment can have the light source 30 on the substrate 2, thus ensuring space-efficient layout of light sources, and ensuring efficient wiring. Further, it is possible to provide the light source 30 with a function other than the function of supplying back light by using the arrangement of the light source 30.

In the metal dome sheet 10 of the embodiment, as shown in FIG. 1, the colored layer 24 is provided at the top side of the metal dome sheet 10 at the area where the reflection means 14 is provided at the bottom side of the metal dome sheet 10. The key top 16 can be illuminated with light having a color according to the colored layer 24 by making illuminated light which is reflected by the reflection means 14 to enter the overlying key top 16 pass through the colored layer 24. It is noted that the position where the colored layer 24 is provided is not limited to the top side of the metal dome sheet 10 as shown in FIG. 1, and can be provided at bottom side of the metal dome sheet 10 where the reflection means 14 is provided, or can be provided inside the metal dome sheet 10. When the colored layer 24 is provided inside the metal dome sheet 10, however, the colored layer 24 should be provided not to influence the illuminated light which passes through the metal dome sheet 10 to enter other key tops 16.

As a method of providing the colored layer, any coloring means including various kinds of print methods can be used.

In the metal dome sheet 10 of the embodiment, as described above, even when white light is generated from the light source 30, the light can pass through the colored layer 24, thus allowing illuminated light having desired color to be supplied to the key top 16 as back light. This makes it possible to provide a highly decorative push button switch 4 whose key top is illuminated with light of various colors.

While the provision of the colored layer 24 at the key top 16 can allow the key top 16 to be illuminated with light of various colors, when the colored layer 24 is provided on the key top 16, the key top 16 is indicated by the color of the colored layer even when illuminated light is off.

When the colored layer 24 is provided at the metal dome sheet 10, on the other hand, the key top 16 is indicated by the color of the colored layer only when illuminated light is on, which can provide an operator with surprising or strong impression, so that a more attractive push button switch 4 can be provided.

### (Description of Other Embodiments of Metal Dome Sheet According to the Invention and Push Button Switch Using the Metal Dome Sheet)

The metal dome sheet according to the present invention and the push button switch using this metal dome sheet are not limited to the above mentioned embodiments, and other various embodiments are included in the invention.

### DESCRIPTION OF REFERENCE NUMERALS

2 substrate
4 push button switch
6 contact
8a metal dome
8a top
10 metal dome sheet
12 pressing projection
14 reflection means
16 key top
16a top surface (operational surface)
18 key base
20 casing
20a clearance
22 mask sheet
24 colored layer
26 outlined character, numeral or the like
28 adhesive
30 light source
102 substrate
104 push button switch
106 contact
108 metal dome
108a top
110 metal dome sheet
112 pressing projection
116 key top
118 key base
120 casing

1. A metal dome sheet to which metal dome(s) are attached,
said metal dome elastically deforms with a pressing operation of a key top, thereby to have electrical conduction with a contact provided on a substrate, and restores from a deformed state when the pressing operation is released, thereby to release the conduction with said contact,
said metal dome sheet having an elastic pressing projection which transmits pressing force applied from the key top side to a top of said metal dome.

2. The metal dome sheet according to claim 1, comprising:
at least one light source mounted to supply illuminated light; and
a reflection means which reflects at least a part of the illuminated light toward said key top, said reflection means being provided at an area where said key top is located,
whereby said metal dome sheet functions as a light guide plate.

3. The metal dome sheet according to claim 2, wherein a colored layer is provided at the area where said reflection means is provided.

4. A push button switch comprising:
a key top;
a metal dome which elastically deforms with a pressing operation of the key top, thereby to have electrical conduction with a contact provided on a substrate, and restores from a deformed state when the pressing operation is released, thereby to release the conduction with said contact;
a metal base sheet to which said metal dome(s) are attached and functioning as a light guide plate, said metal base sheet having an elastic pressing projection which transmits pressing force applied from the key top side to a top of said metal dome, and further having at least one light source mounted to supply illuminated light, and a reflection means which reflects at least a part of the illuminated light toward said key top, said reflection means being provided at an area where said key top is located.

5. A method of manufacturing a push button switch using a metal dome sheet having a pressing projection, comprising:
a first step of attaching metal dome(s) to the metal dome sheet in such a way that a position of a top of said metal dome matches with a position of said pressing projection;
a second step of mounting said metal dome sheet to which said metal dome(s) are attached on a substrate; and
a third step of mounting a key top member on said substrate with said metal dome sheet at a position where said metal dome is located.
